(19) United States
(12) Patent Application Publication
(10) Pub. No.: US 2022/0311274 A1
(43) Pub. Date: Sep. 29, 2022

(54) Wireless Charging Assembly

(71) Applicant: Samuel George, Wellman, IA (US)

(72) Inventor: Samuel George, Wellman, IA (US)

(21) Appl. No.: 17/210,666

(22) Filed: Mar. 24, 2021

(51) Int. Cl. H02J 50/10; H04M 1/02; H04B 1/3883; H04M 1/04; H02J 7/00

(52) U.S. Cl. CPC H02J 50/10; H04M 1/0262; H04B 1/3883; H04M 1/04; H02J 7/0044

(57) ABSTRACT

A wireless charging assembly for portably charging a smart device includes a smart device case that can insertably receive a smart device. The smart device case is comprised of a rigid material to protect the smart device from impact damage. A plurality of first mating units is each integrated into the smart device case. A wireless charger is positionable against the smart device case and the wireless charger is in wireless communication with the smart device. The wireless charger broadcasts a charging signal to wirelessly charge the smart device. A plurality of second mating units is each integrated into the wireless charger. Each of the second mating units releasably engages a respective for retaining the wireless charger on the smart device case.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to charging devices and more particularly pertains to a new charging device for portably charging a smart device. The device includes a smart device case, a portable wireless charger and a plurality of magnets that engage each other to retain the portable wireless charger on the smart device case. In this way the smart device can be wirelessly charged while the smart device is being carried.

### (2) Description of Related Art Including Information Disclosed Under 37 CFR 1.97 and 1.98

The prior art relates to charging devices including a variety of smart phone cases that include a power supply for extending the battery life of a smart phone. The prior art also discloses a smart phone case and a wireless charger that can be magnetically attached to the smart phone case for wirelessly charging a smart phone. The prior art does not disclose a smart phone case and wireless charger that includes magnets which are arranged into a rectangle for retaining the wireless charger on the smart phone case.

### BRIEF SUMMARY OF THE INVENTION

An embodiment of the disclosure meets the needs presented above by generally comprising a smart device case that can insertably receive a smart device. The smart device case is comprised of a rigid material to protect the smart device from impact damage. A plurality of first mating units is each integrated into the smart device case. A wireless charger is positionable against the smart device case and the wireless charger is in wireless communication with the smart device. The wireless charger broadcasts a charging signal to wirelessly charge the smart device. A plurality of second mating units is each integrated into the wireless charger. Each of the second mating units releasably engages a respective for retaining the wireless charger on the smart device case.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an exploded perspective view of a wireless charging assembly according to an embodiment of the disclosure.

FIG. 2 is a back phantom view of an embodiment of the disclosure.

FIG. 3 is a right side exploded view of an embodiment of the disclosure.

FIG. 4 is a front view of a wireless charger of an embodiment of the disclosure.

### DETAILED DESCRIPTION OF THE INVENTION

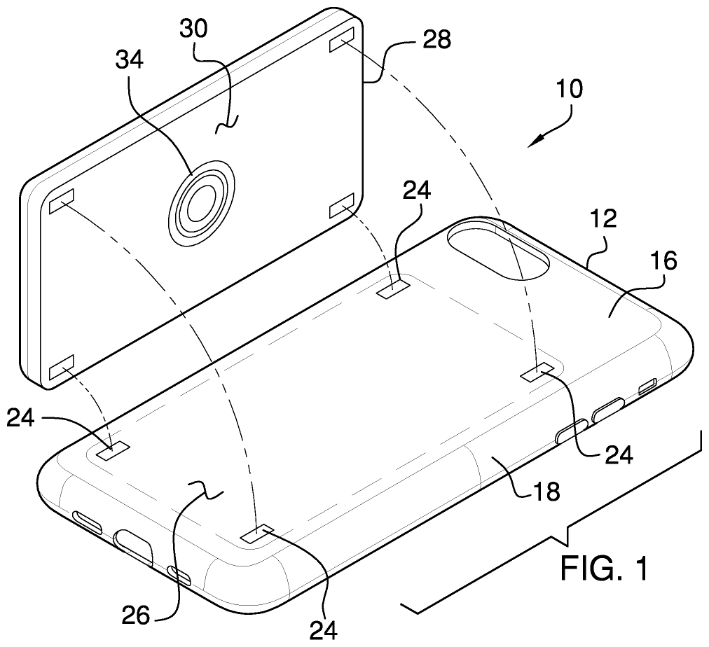

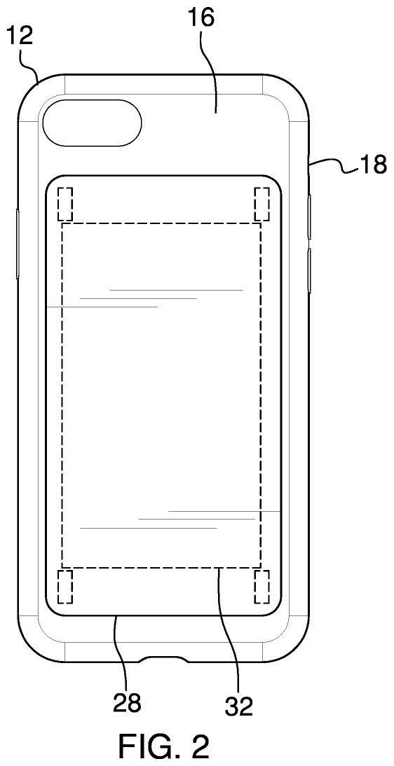

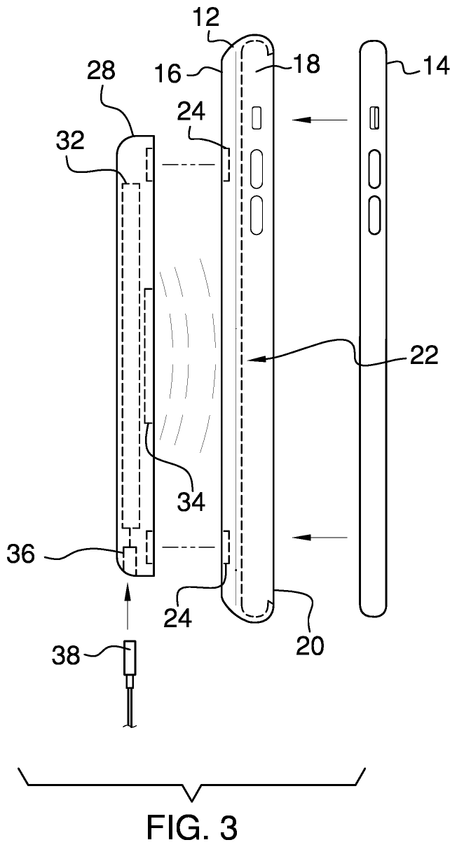

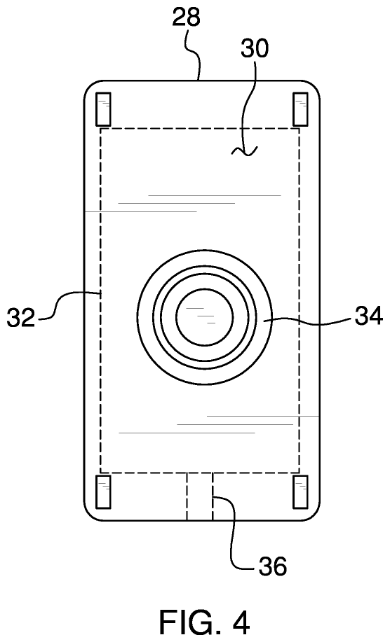

With reference now to the drawings, and in particular to FIGS. 1 through 4 thereof, a new charging device embodying the principles and concepts of an embodiment of the disclosure and generally designated by the reference numeral 10 will be described.

As best illustrated in FIGS. 1 through 4, the wireless charging assembly 10 generally comprises a smart device case 12 is configured to insertably receive a smart device 14. The smart device case 12 is comprised of a rigid material to protect the smart device 14 from impact damage. The smart device case 12 has a back wall 16 and a perimeter wall 18 extending away from the back wall 16. The perimeter wall 18 has a distal edge 20 with respect to the back wall 16 defining an opening 22 into the smart device case 12 to receive the smart device 14. The smart device 14 may be a smart phone, a tablet or any other portable electronic device that can be wirelessly charged. Additionally, the smart device case 12 may be structured in the convention and design of any existing smart device case

A plurality of first mating units 24 is provided and each of the first mating units 24 is integrated into the smart device case 12. Each of the first mating units 24 is recessed into a back surface 26 of the back wall 16 of the smart device case 12. Additionally, each of the first mating units 24 is positioned on the back wall 16 of the case to define a respective one of four corners of a rectangle. Each of the first mating units 24 may comprise a magnet or other type of releasable, mechanical fastener.

A wireless charger 28 is provided and the wireless charger 28 is positionable against the smart device case 12 such that the wireless charger 28 can be in wireless communication with the smart device 14. The wireless charger 28 broadcasts a charging signal to wirelessly charge the smart device 14. The wireless charger 28 has a first surface 30 and the wireless charger 28 includes a battery 32 and a transmitter 34. The transmitter 34 is electrically coupled to the battery 32 and the transmitter 34 is integrated into the first surface 30 of the wireless charger 28. The transmitter 34 may comprise an induction coil that produces an alternating electromagnetic field which is converted into electricity by a receiver coil in the smart device 14.

The first surface 30 of the wireless charger 28 abuts the back surface 26 of the back wall 16 of the smart device case 12 when the wireless charger 28 is positioned in a charging position. The transmitter 34 broadcasts the charging signal and the transmitter 34 is in wireless communication with the smart device 14 when the first surface 30 of the wireless charger 28 is positioned in the charging position. The wireless charger 28 might include a charge port 36 that is electrically coupled to the battery 32 and which can receive a charge cord 38 for charging the battery 32.

A plurality of second mating units 40 is provided and each of the second mating units 40 is integrated into the wireless charger 28. Each of the second mating units 40 releasably engages a respective one of the first mating units 24 when the wireless charger 28 is positioned against the smart device case 12. In this way the wireless charger 28 is retained on the smart device case 12. Each of the second mating units 40 is recessed into the first surface 30 of the wireless charger 28. Additionally, each of the second mating units 40 is positioned on the first surface 30 to define a respective one of four corners of a rectangle. Each of the second mating units 40 is aligned with a respective one of the first mating units 24 when the wireless charger 28 is positioned in the charging position. Each of the second mating units 40 may comprise a magnet or other type of releasable, mechanical fastener that is complementary to the first mating units 24.

In use, the smart device 14 is positioned in the smart device case 12 to facilitate normal operation of the smart device 14. The wireless charger 28 is positioned against the back wall 16 of the smart device case 12 such that the first mating units 24 engage the second mating units 40. In this way the smart device 14 can be wirelessly charged while the smart device 14 is being carried. Thus, the wireless charger 28 enhances the operational service life of the smart device 14 without requiring the smart device 14 to be plugged into a wall charger.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A wireless charging assembly for wirelessly charging a smart device in a portable manner, said assembly comprising:
a smart device case being configured to insertably receive a smart device, said smart device case being comprised of a rigid material wherein said smart device case is configured to protect the smart device from impact damage;
a plurality of first mating units, each of said first mating units being integrated into said smart device case;
a wireless charger being positionable against said smart device case wherein said wireless charger is configured to be in wireless communication with the smart device, said wireless charger broadcasting a charging signal wherein said wireless charger is configured to wirelessly charge the smart device; and
a plurality of second mating units, each of said second mating units being integrated into said wireless charger, each of said second mating units releasably engaging a respective one of said first mating units when said wireless charger is positioned against said smart device case for retaining said wireless charger on the smart device case.

2. The assembly according to claim 1, wherein:
said smart device case has a back wall and a perimeter wall extending away from said back wall, said perimeter wall having a distal edge with respect to said back wall defining an opening into said smart device case wherein said opening is configured to receive the smart device; and
each of said first mating units is recessed into a back surface of said back wall of said smart device case, each of said first mating units being positioned on said back wall of said case to define a respective one of four corners of a rectangle.

3. The assembly according to claim 2, wherein said wireless charger has a first surface, said wireless charger including a battery and a transmitter, said transmitter being electrically coupled to said battery, said transmitter being integrated into said first surface of said wireless charger, said first surface of said wireless charger abutting said back surface of said back wall of said smart device case when said wireless charger is positioned in a charging position, said transmitter broadcasting said charging signal wherein said transmitter is configured to be in wireless communication with the smart device when said first surface of said wireless charger is positioned in said charging position.

4. The assembly according to claim 1, wherein:
said smart device case has a back wall, said back wall having a back surface;
each of said first mating units is recessed into said back surface of said back wall of said smart device case;
said wireless charger has a first surface; and
each of said second mating units is recessed into said first surface of said wireless charger, each of said second mating units being positioned on said first surface to define a respective one of four corners of a rectangle, each of said second mating units being aligned with a respective one of said first mating units when said wireless charger is positioned in said charging position.

5. A wireless charging assembly for wirelessly charging a smart device in a portable manner, said assembly comprising:
a smart device case being configured to insertably receive a smart device, said smart device case being comprised of a rigid material wherein said smart device case is configured to protect the smart device from impact damage, said smart device case having a back wall and a perimeter wall extending away from said back wall, said perimeter wall having a distal edge with respect to said back wall defining an opening into said smart device case wherein said opening is configured to receive the smart device;
a plurality of first mating units, each of said first mating units being integrated into said smart device case, each of said first mating units being recessed into a back surface of said back wall of said smart device case, each of said first mating units being positioned on said back wall of said case to define a respective one of four corners of a rectangle;
a wireless charger being positionable against said smart device case wherein said wireless charger is configured to be in wireless communication with the smart device, said wireless charger broadcasting a charging signal wherein said wireless charger is configured to wirelessly charge the smart device, said wireless charger having a first surface, said wireless charger including a battery and a transmitter, said transmitter being electrically coupled to said battery, said transmitter being integrated into said first surface of said wireless charger, said first surface of said wireless charger abutting said back surface of said back wall of said smart device case when said wireless charger is positioned in a charging position, said transmitter broadcasting said charging signal wherein said transmitter is configured to be in wireless communication with the smart device when said first surface of said wireless charger is positioned in said charging position; and
a plurality of second mating units, each of said second mating units being integrated into said wireless charger, each of said second mating units releasably engaging a respective one of said first mating units when said wireless charger is positioned against said smart device case for retaining said wireless charger on the smart device case, each of said second mating units being recessed into said first surface of said wireless charger, each of said second mating units being positioned on said first surface to define a respective one of four corners of a rectangle, each of said second mating units being aligned with a respective one of said first mating units when said wireless charger is positioned in said charging position.

6. A wireless charging system for wirelessly charging a smart device in a portable manner, said system comprising:
a smart device having wireless charging capabilities;
a smart device case insertably receive said smart device, said smart device case being comprised of a rigid material to protect said smart device from impact damage, said smart device case having a back wall and a perimeter wall extending away from said back wall, said perimeter wall having a distal edge with respect to said back wall defining an opening into said smart device case to receive said smart device;
a plurality of first mating units, each of said first mating units being integrated into said smart device case, each of said first mating units being recessed into a back surface of said back wall of said smart device case, each of said first mating units being positioned on said back wall of said case to define a respective one of four corners of a rectangle;
a wireless charger being positionable against said smart device case such that said wireless charger is in wireless communication with said smart device, said wireless charger broadcasting a charging signal to wirelessly charge said smart device, said wireless charger having a first surface, said wireless charger including a battery and a transmitter, said transmitter being electrically coupled to said battery, said transmitter being integrated into said first surface of said wireless charger, said first surface of said wireless charger abutting said back surface of said back wall of said smart device case when said wireless charger is positioned in a charging position, said transmitter broadcasting said charging signal such that said transmitter is in wireless communication with said smart device when said first surface of said wireless charger is positioned in said charging position; and
a plurality of second mating units, each of said second mating units being integrated into said wireless charger, each of said second mating units releasably engaging a respective one of said first mating units when said wireless charger is positioned against said smart device case for retaining said wireless charger on said smart device case, each of said second mating units being recessed into said first surface of said wireless charger, each of said second mating units being positioned on said first surface to define a respective one of four corners of a rectangle, each of said second mating units being aligned with a respective one of said first mating units when said wireless charger is positioned in said charging position.
